(19) United States
(12) Patent Application Publication
(10) Pub. No.: US 2020/0001596 A1
(43) Pub. Date: Jan. 2, 2020

(54) Device for Cleaning Ink Reservoir, Printing Machine, and Method for Cleaning Ink Reservoir

(71) Applicant: I.MER CO., LTD., Kyoto-shi (JP)

(72) Inventor: Masayuki Izume, Kyoto-shi (JP)

(21) Appl. No.: 16/489,546

(22) PCT Filed: Nov. 27, 2017
(86) PCT No.: PCT/JP2017/042331

§ 371 Date: Aug. 28, 2019

(30) Foreign Application Priority Data
Jun. 1, 2017 (JP) 2017-108878
Jul. 13, 2017 (JP) 2017-136919

(51) Int. Cl. B41F 31/05; B41F 31/08

(52) U.S. Cl. CPC B41F 31/05; B41F 31/14; B41F 31/08

(57) ABSTRACT

A printing press makes an ink reservoir between an ink fountain and an ink fountain roller and supplies ink to the plate cylinder via a ductor roller advancing and retracting towards and from the ink fountain roller. The printing press is provided with the ink fountain, a base supporting the ink fountain, a slide mechanism sliding the ink fountain along the base in order to control the clearance between the tip of the ink fountain and the ink fountain roller, a cleaner removing the ink from the ink fountain roller, an advancement and retraction mechanism for advancing and retracting the cleaner between a contact position to the ink fountain roller and a non-contact position, and a controller. The controller controls the slide mechanism and the advancement and retraction mechanism, enlarges the clearance in order to pass the dirt with the ink through the clearance, and makes the cleaner in contact with the ink fountain roller to remove the dirt with the ink.

### FIELD OF THE INVENTION

The present invention relates to cleaning the ink reservoir in a printing press.

### BACKGROUND ART

With the increasing frequency of printing on recycled papers, there becomes apparent a problem that printing presses are contaminated by paper dust. The paper dust moves from a blanket cylinder and so on to the ink fountain with ink and clogs the clearance between the ink fountain and the ink fountain roller. Therefore, the ink flow through the ink fountain roller towards the ductor roller is decreased, and printing density decreases. As a result, workmen have to clean the ink fountain to remove paper dust. This is an additional job to the workmen and makes the printing halted during the cleaning.

Related pieces of the prior art are described. According to Patent Document 1 (JP3194174B), the surface of the ink fountain is covered with a sheet freely windable and feedable. The sheet is wound up and fed to cover the ink fountain with a new face of the sheet when changing the ink. Further, the ink on the ink fountain roller is scraped by a blade.

According to Patent Document 2 (JP2866997B), the ductor roller is divided into plural individual rollers. The individual ductor rollers have adjustable individual contact periods to the ink fountain roller so that the printing density is adjustable for the individual ductor rollers. By the way, conventional ductor rollers advance and retract as a whole towards and from the ink fountain roller and are not divided into the individual rollers.

### CITATION LIST

### Patent Document

Patent Document 1: JP3194174B

Patent Document 2: JP2866997B

### SUMMARY OF THE INVENTION

### Problems to be Solved by the Invention

The Object of the Invention is

### Means for Solving the Problems

According to an inventive cleaning device for an ink reservoir for a printing press, the ink reservoir is formed between an ink fountain and an ink fountain roller and ink is supplied to a ductor roller advancing and retracting towards and from the ink fountain roller,
one end of the ink fountain towards the ink fountain roller is a tip end and an opposite end of the ink fountain far from the ink fountain roller is a rear end,
said cleaning device for an ink reservoir comprises: the ink fountain; a base supporting the ink fountain; and a slide mechanism sliding the ink fountain along the base in order to control a clearance between the tip end of the ink fountain and the ink fountain roller, and
said slide mechanism is configured to slide the ink fountain between a normal position where the ink passes through said clearance and a cleaning position where both dirt in the ink and the ink pass through said clearance.

According to an inventive printing press, an ink reservoir is formed between an ink fountain and an ink fountain roller and ink is supplied to a plate cylinder via a ductor roller advancing and retracting towards and from the ink fountain roller,
one end of the ink fountain towards the ink fountain roller is a tip end and an opposite end of the ink fountain far from the ink fountain roller is a rear end,
the printing press comprises: the ink fountain; a base supporting the ink fountain; a slide mechanism sliding the ink fountain along the base in order to control a clearance between the tip end of the ink fountain and the ink fountain roller; a cleaner for removing the ink from the ink fountain roller; an advancement and retraction mechanism advancing and retracting the cleaner between a contact position where the cleaner is in contact with the ink fountain roller and a non-contact position where the cleaner is not in contact with the ink fountain roller; and a controller controlling said slide mechanism and said advancement and retraction mechanism,
said slide mechanism is configured to slide the ink fountain between a normal position where the ink passes through said clearance and a cleaning position where both dirt in the ink and the ink pass through said clearance, and
said controller is configured to control the slide mechanism and the advancement and retraction mechanism in order to make the cleaner advance to the contact position in synchronization with the slide of the ink fountain.

According to an inventive cleaning method for an ink reservoir for a printing press, the ink reservoir is formed between an ink fountain and an ink fountain roller and ink is supplied to a plate cylinder via a ductor roller advancing and retracting towards and from the ink fountain roller,
one end of the ink fountain towards the ink fountain roller is a tip end and an opposite end of the ink fountain far from the ink fountain roller is a rear end,
the printing press comprises: the ink fountain; a base supporting the ink fountain; a slide mechanism sliding the ink fountain along the base in order to control a clearance between the tip end of the ink fountain and the ink fountain roller; a cleaner for removing the ink from the ink fountain roller; an advancement and retraction mechanism advancing and retracting the cleaner between a contact position where the cleaner is in contact with the ink fountain roller and a non-contact position where the cleaner is not in contact with the ink fountain roller; and a controller, and
said method comprises: controlling said slide mechanism and said advancement and retraction mechanism by said controller; enlarging said clearance, and passing dirt in the ink and the ink through said clearance; making the cleaner in contact with the ink fountain roller; in synchronization with enlarging said clearance; and removing the dirt in the ink and the ink by the cleaner.

According to the invention, the ink fountain is slid and retracted by the slide mechanism along the base to the cleaning position. At the cleaning position, the clearance between the tip end of the ink fountain and the ink fountain roller is enlarged from the normal position, and the clogged ink with dirt such as paper dust is discharged through the clearance. When the cleaning of the ink reservoir is completed, the ink fountain is advanced towards the ink fountain roller and is returned to the normal position; the clearance between the ink fountain and the ink fountain roller is returned to the normal value. Between the cylinder plate and the ink fountain roller, there are the ductor roller and ink distributing rollers; the printing is continued during the cleaning with the ink stored on these rollers. Then after the cleaning, the clearance between the ink fountain and the ink fountain roller is returned to the normal value.

The ink passed during the cleaning through the clearance between the ink fountain and the ink fountain roller is removed by a cleaner such as a doctor blade, a brush. Here, the cleaner is provided between the tip end of the ink fountain and the ductor roller along the rotational direction of the ink fountain roller. In synchronization with enlarging the clearance between the ink fountain and the ink fountain roller, the cleaner is made in contact with the ink fountain roller in order to remove the dirt in the ink and the ink.

In this specification, a movement towards the ink fountain roller is called an advancement, and a movement opposite to the ink fountain roller is called a retraction. More, the direction parallel to the tip end of the ink fountain (the direction parallel to the axis of the ink fountain roller) is called the left-right direction. Relative to the ink fountain, the end towards the ink fountain roller is called the tip end, the opposite end is the base end. Furthermore, in this specification, descriptions about the cleaning device are applicable to the printing press and the cleaning method, as they are.

Preferably, said slide mechanism is provided at left and right two portions of the rear end of the ink fountain and is configured to slide the left and right two portions of the rear end of the ink fountain by the same stroke. Thus, the tip end of the ink fountain is kept parallel to the axis of the ink fountain roller, and the clearance between the ink fountain and the ink fountain roller is kept constant along the tip end of the ink fountain.

Preferably, said slide mechanism comprises:
a left-right pair of feed screw mechanisms comprising screws and nuts connected to and provided at the rear end of the ink fountain;
a left-right pair of arms rocking said nuts;
a rod connecting said left-right pair of arms rockingly;
a drive member rocking one of the arms; and
plural biasing members elastically pressing the ink fountain towards the ink fountain roller.
Further, the rear end of the ink fountain, the left-right pair of the feed screw mechanisms, the left-right pair of the arms, and the rod constitute a quadric link.

Since the quadric link makes the left-right pair of the arms rock by the same angle, the nuts in the feed screw mechanisms rock, and therefore, the screws advance and retract with a small stroke by the same length. While the drive member may be an air cylinder or the like, a servo motor as the drive member may precisely adjust the clearance between the ink fountain and the ink fountain roller according to the species of the ink, desired printing density, etc.

Preferably, said slide mechanism comprises at least a linear motor provided between the base and the ink fountain.

The linear motor makes the ink fountain slide without a gear and a screw, and therefore, no backlash is caused. Further, the linear motor may be provided between the base and the ink fountain, spaces at the rear end of the ink fountain is not occupied. Therefore, the slide mechanism does not need an additional space.

Preferably, the ink fountain is downwardly inclined where the tip end is down and the rear end is up, and, when the power supply to the linear motor is made off, then the ink fountain slides to the closed position by its own weight. Here, the force applied by the ink fountain to the ink fountain roller is less than the weight of the ink fountain, and an excessive force does not apply. While the linear motor uses the combination of an electromagnet, and a permanent magnet, antimagnetic body, or a magnetic body, etc., a piezoelectric linear motor having a piezoelectric body, etc. are usable.

Preferably, the linear motor is provided with an encoder, and the controller is configured to control the clearance at the normal position between the ink fountain and the ink fountain roller, assuming that, at the encoder value when the power supply is made on, the ink fountain is at the closed position. When a linear motor is used, the ink fountain slides naturally to the closed position, when the power supply is made off, and therefore, the encoder output when the power supply is made on represents one at the closed position. As a result, when controlling the normal position of the ink fountain, assuming that the encoder output when the power supply is made on corresponds to that at the origin (the closed position), the normal position of the ink fountain is simply and accurately controlled.

Preferably, a seal blocking the ink is provided between the ink fountain and the base so that dirt such as ink mist is prevented from entering between the ink fountain and the base. The seal is, for example, an elastic body such as rubber, and may be a self-lubricant sheet or a plate made of TEFLON (a registered trademark) or the like; the material of the seal is arbitrary.

Preferably, at least a guide member guiding the ink fountain along a sliding direction of the ink fountain in line contact with the ink fountain is provided between the base and bottom of the ink fountain. As a result, the ink fountain may smoothly be guided along the slide direction.

Preferably, a compensation means for increasing the quantity of the ink received by the ductor roller from the ink fountain roller before or after the slide of the ink fountain to the cleaning position is provided. When the ink fountain is retracted to the cleaning position and the cleaner is advanced, then the ink mixed with dirt is recovered. Then, the ink quantity received by the ductor roller may be decreased. Therefore, the compensation means increases the ink quantity received by the ductor roller from the ink fountain roller before the slide of the ink fountain to the cleaning position or after that. Then, the decrease in printing density according to the cleaning of the ink reservoir is reduced.

For example, said compensation means is configured to feed the ink to the ink reservoir before or after, preferably both before and after, the slide of the ink fountain to the cleaning position. When the ink quantity in the ink reservoir increases, then, the ink quantity passing through the clearance between the ink fountain roller and the ink fountain increases. For example, before the cleaning, the ink is fed in order to supply the ink which will be consumed by the cleaning in advance to the ductor roller, the ink distributing rollers, and so on. Or the ink is fed after the cleaning in order to supply the ink consumed by the cleaning to the ductor roller, the ink distributing rollers, and so on.

Preferably, said ductor roller is configured to be in contact with the ink fountain roller at a variable duty ratio, and
said compensation means is configured to increase said duty ratio before or after, preferably both before and after, the slide of the ink fountain to the cleaning position. When the duty ratio is increased, the ink quantity received by the ductor roller from the ink fountain roller is increased, and thus, the ink consumed by the cleaning is compensated.

Preferably, said ductor roller comprises plural individual rollers arranged along an axial direction of the ink fountain roller and advancing and retracting separately to contact the ink fountain roller, and
said controller is configured to control the slide mechanism and the advancement and retraction mechanism so that said plural individual rollers are made, by a same number of times, in contact with a cleaned surface on the ink fountain roller from where the ink is removed by the cleaner, when sliding the ink fountain to the cleaning position.

Then, the cleaning effects evenly to the plural individual rollers, and the variations in printing densities along the axial direction of the ductor roller are prevented.

Preferably, said slide mechanism is configured to slide the ink fountain to three positions of the normal position, the cleaning position, and a closed position where the tip end of the ink fountain advances towards the ink fountain roller and prevents leakage of the ink through said clearance. Printing is performed at the normal position, the cleaning of the ink reservoir is performed at the cleaning position, and the leakage of the ink from the ink reservoir is prevented at the closed position. Therefore, if the ink is remaining in the ink reservoir during a halting period of the printing press, such as at night, the ink does not leak.

### BRIEF DESCRIPTION OF THE DRAWINGS

FIG. 1 A side view of a printing press in major portions according to an embodiment.

FIG. 2 A rear view of the printing press in major portions according to the embodiment.

FIG. 3 A plan view showing the connection portion between an arm and a screw feeding mechanism according to the embodiment.

FIG. 4 A side view showing a biasing mechanism for the ink fountain according to the embodiment.

FIG. 5 A view showing a guide member for the ink fountain according to the embodiment.

FIG. 6 A view showing a modification having an air cylinder as a drive mechanism.

FIG. 7 A view showing a further modification having a servo motor with a double-headed shaft as a drive mechanism.

FIG. 8 A block diagram showing a control system of the cleaning device according to the embodiment.

FIG. 9 A diagram showing an operational algorithm according to the embodiment.

FIG. 10 A diagram showing the movements of the ductor roller, the ink fountain, and a blade during the cleaning of the ink fountain according to the embodiment.

FIG. 11 A plan view showing the ink fountain over a base according to the best embodiment.

FIG. 12 A side view of the printing press in major portions according to the best embodiment.

FIG. 13 A diagram showing the control of the linear motors according to the best embodiment.

FIG. 14 A diagram showing the operational algorithm according to the best embodiment.

FIG. 15 A diagram showing a slide mechanism of the ink fountain according to a modification.

FIG. 16 A diagram showing an ink feeding device and the drive device for the ductor roller of the printing press according to the embodiment.

FIG. 17 A diagram showing ink feeding before and after the cleaning according to the embodiment.

FIG. 18 A diagram showing the increase in the duty ratio of the ductor roller before and after the cleaning according to the embodiment.

FIG. 19 A diagram showing synchronous operations of the individual ductor rollers and the cleaning according to the embodiment.

### PREFERRED EMBODIMENT FOR CARRYING OUT THE INVENTION

The best embodiment for carrying out the invention will be described in the following.

### Embodiment

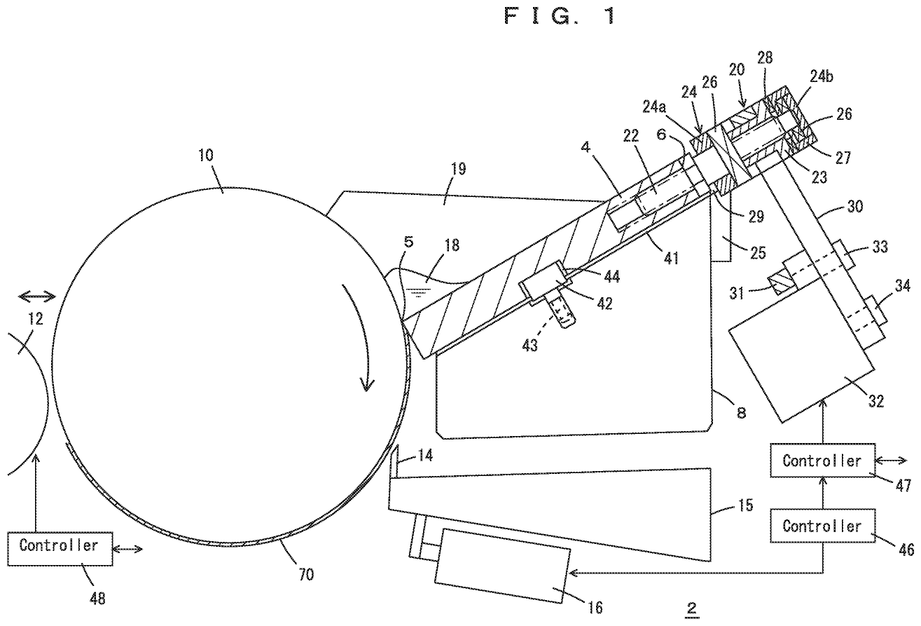

FIGS. 1 to 10 indicate an embodiment. FIG. 1 shows the major portions of the printing press. The printing press is an offset printing press but may be a letterpress printing press. Printing is performed on papers but may be done on cans or discs such as CD-ROMs. When printing on cans and discs, foreign matters such as water mist introduced from the water fountain are removed from the ink reservoir.

The tip end 5 of the ink fountain 4 is abutting and parallel to the ink fountain roller 10. The clearance between the tip end 5 and the roller 10 is changed in three ways: close contact where the clearance is nearly 0 (e.g. 10 μm or less); normal (e.g. about 0.05 mm-0.2 mm); and cleaning (eg. 0.2 mm-0.3 mm). At the rear end 6 of the ink fountain 4, there are provided a left-right pair of feed screw mechanisms 20. Double-headed screws 22 are made advanced and retracted by nuts 23, and thus, the ink fountain 4 is slid to the three positions. The ink fountain 4 is supported by a base 8 via guide members 42 and has a clearance 41 at other portions between the base 8 and the bottom of the ink fountain 4. In the specification, left and right indicate a direction parallel to the axis of the ink fountain roller 10 and the lengthwise direction of the rear end 6. Regarding advancement and retraction, a motion towards the ink fountain roller 10 is an advancement and a motion away it is a retraction.

There is the ink reservoir 18 between the ink fountain roller 10 and the ink fountain 4, and, through an ink supply portion 17, the ink is supplied from the ink reservoir 18 with the control by a controller 46. The ink fountain roller 10 draws the ink from the ink reservoir 18 as an ink film 70 and supplies to ink distributing rollers, not shown in the drawings, through the ductor roller 12. The ductor roller 12 is divided into plural individual rollers along its axis direction; the individual rollers advance and retract separately towards and from the ink fountain roller 10 in order to control separately the contact period with the ink fountain roller 10. However, conventional ductor rollers not divided into the individual rollers are usable. The ark-shaped arrow in FIG. 1 indicates the rotational direction of the ink fountain roller 10, and the horizontal arrow indicates the advancement and retraction direction of the ductor roller 12. Blades 19 at the left and right ends of the ink fountain 4 prevent the ink from leaking from the left and right ends of the ink reservoir 18 and are in close contact with the ink fountain roller 10 and the ink fountain 4 by permanent magnets or the like.

A doctor blade 14 (called “blade” below) under the ink reservoir 4 scrapes the ink film 70 from the ink fountain roller 10, and the scraped ink is stored in a pan 15. A cylinder 16 such as an air cylinder moves the blade 14 between a cleaning position for scraping the ink film 70 and a retracted position away from the ink fountain roller 10.

FIG. 1 indicates one unit for one colored ink in the printing press, without the frame or the like for supporting various elements of the printing press; the printing press is provided with multiple units corresponding to CMYK and so on. Each unit has ink distributing rollers, the plate cylinder, and the blanket cylinder for printing on papers; they are not shown in the drawings.

The ink fountain 4 is covered by a sheet not shown, supplied from an upper portion of the rear end 6 of the ink fountain 4, and wound between the base 8 and the pan 15. The sheet may not be provided and is not shown in the drawings in the embodiment. The clearance between the ink fountain 4 and the ink fountain roller 10 is indicated by the clearance excluding the sheet thickness.

Indicated by 46 is a controller for the entire unit, by 47 a controller for a servo motor 32, and by 48 a controller for the drive mechanism of the ductor roller 12. The controllers 46-48 may be provided separately or may be integrated into one controller. Further, the whole controllers 46-48 correspond to the controller in the claims.

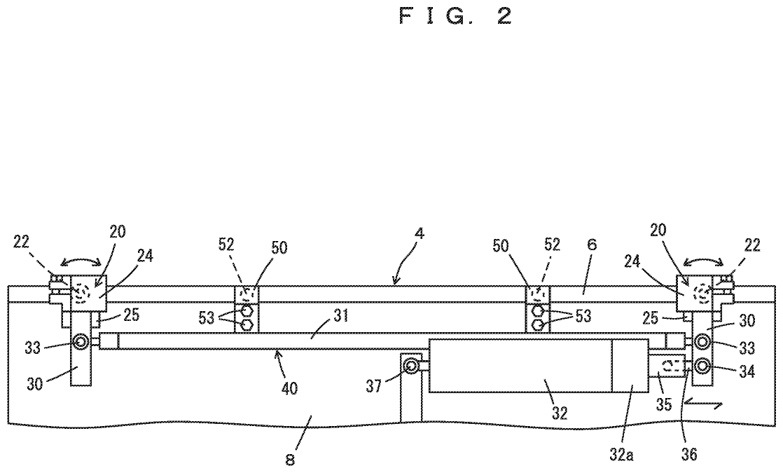

The cleaning device 4 comprises: the ink fountain roller 10; the left-right pair of the feed screw mechanisms 20; a quadric link 40 shown in FIG. 2 driving the feed screw mechanisms 20; the servo motor 32, the blade 14, the pan 15; the cylinder 16; and the controller 47 for the servo motor 32.

The feed screw mechanisms 20 will be described. At the rear end 6 of the ink fountain 4, one of the heads of the double-headed screw 42 is screwed, the other head is engaged with the nut 23, and the nut 23 is supported by a fixing member 24. The fixing member 24 is fixed to the base 8 at a fixed portion 25, pinches the nut 23 with elements 24a, 24b, and has a thrust bearing 26 between the nut 23 and the element 24a at the side of the ink fountain 4. There is provided a biasing member 28 between the nut 23 and the element 24b opposite to the ink fountain 4; it presses elastically the nut 23 towards the thrust bearing 26 and is supported by an intermediate member 27. The bearing 26 is provided between the intermediate member 27 and the element 24 at the end. Thus, the nut 23 is biassed towards the thrust bearing 26 and is made to rock around its axis relative to the fixing member 24. There is provided a clearance 29 between the element 24a and the double-headed screw 22, and similarly is provided a clearance between the element 24b and the tip of the double-headed screw 22. Therefore, the double-headed screw 22 can advance and retract relative to the fixing member 24.

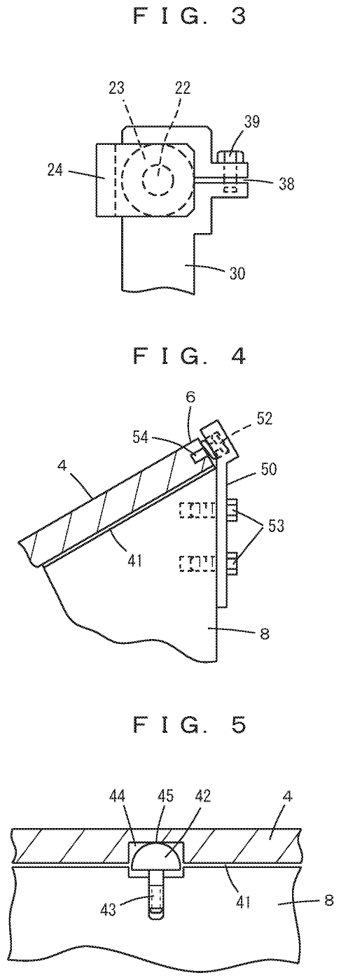

With reference to FIGS. 1-3, the relation of the feed screw mechanisms 20 and the quadric link 40 will be described. As shown in FIG. 2, the feed screw mechanisms 20 are provided at two positions on the left and right of the rear end 6 of the ink fountain 4. The nut 23 is engaged with an arm 30 of the quadric link 40, and a bolt 39, shown in FIG. 3, prohibits the slip of the nut 23 to the arm 30. A connection rod 31 is rockingly connected to the arms 30 by pins 33, and namely, a left-right pair of the arms 30, 30 are connected by the rod 31. Thus, the quadric link 40 consists of the rear end 6, the arms 30, 30, and the rod 31. A screw 36 is rockingly connected to one of the arms 30 by a pin 34. The servo motor 32 as the driver is provided with a shaft 35 having a screw hole at its tip, and, into this screw hole, the screw 36 is engaged and moves back and forth.

Concerning the quadric link 40, the screw 36 advances and retracts by the rotation of shaft 35 of the servo motor 32 for operating the quadric link 40, and the left-right pair of the arms 30, 30 rock by the same angle. Further, the servo motor 32 is rockingly supported by the base 8; for example, the servo motor 32 is rockingly connected by a pin 37 fixed to the base 8.

The feed screw mechanisms 20 and the arms 30 are provided at least at the left and right two positions, but they may be provided at the three positions in the total of the center and left and right. The servo motor 32 is provided with an electromagnetic brake 32a, and the arms 30 are fixed when the power supply is made off, for example: when the printing press is made off at night; or when a momentary power failure is caused.

As shown in FIG. 3, in the arm 30, the hole for receiving the nut 23 extends to a dividing groove 38, the nut 23 is fixed to the arm 30 by a fastening member such as the bolt 39 in order not to slide. When assembling, the nut 23 is rotated to adjust the tip end position of the ink fountain 4 before fastening the bolt 39, and then the bolt 39 is fastened.

With reference to FIGS. 2 and 4, a biasing member 52 for pressing elastically the ink fountain 4 towards the ink fountain roller 10 will be described. Fixing members 50 are provided at least at two positions of the rear end 6, and the biasing members 52 are arranged between the fixing members 50 and the rear end 6. The fixing members 50 are fixed to the base 8 by bolts 53, 53, and the ink fountain 4 is biased towards the ink fountain roller 10 by the biasing members 52. The biasing members 52 are spring-like and are held by pins 54, but the pins 54 may not be provided.

With reference to FIG. 5, guide members 42 guiding the sliding motion of the ink fountain 4 along the lateral direction of the ink fountain 4 will be described. The guide members 42 are secured at their threaded portions 43 to the base 8, the upper portions of the guide members 42 are accommodated within grooves 44 in the ink fountain 4, and the guide members 42 are in line contact with the bottom face of the ink fountain 4 at contact portions 45 which are parallel to the sliding direction of the ink fountain 4. A left-right pair of the guide members 42 are provided; however, three or more may be provided.

When the servo motor 32 operates, then, the left and right arms 30 rock, and the left and right nuts 32 rock thereby. As a result, the left and right double headed screws 22 advance and retract, and the ink fountain 4 advances and retracts left and right equally. Further, the forth and back motion of the ink fountain 4 is supported by the guide members 42, and the biasing members 52 biasing the ink fountain 4 towards the ink fountain roller 10 prevent the backlash caused by the screws 22 and the nuts 23, or the like. Since the servo motor 32 adjusts accurately the clearance between the ink fountain 4 and ink fountain roller 10, the clearance is adjustable according to the species of the ink, aimed printing densities, and so on.

The ink fountain 4 is supported by the nuts 23 through the double-headed screws 22 and also supported by the guide members 42, and there is a clearance between the bottom face of the ink fountain 4 and the upper face of the base 8. Therefore, when the nuts 23 rock, the ink fountain 4 moves forth and back smoothly with the guide by the guide members 42. Further, the ink fountain 4 is pressed elastically towards the ink fountain roller 10 by the biasing members 52: the influence of the backlash is removed; and the ink will be prevented from leaking through the clearance between the ink fountain 4 and the ink fountain roller 10, if the ink fountain 4 will be advanced to a closed position, and if the power supply to the printing will be stopped then.

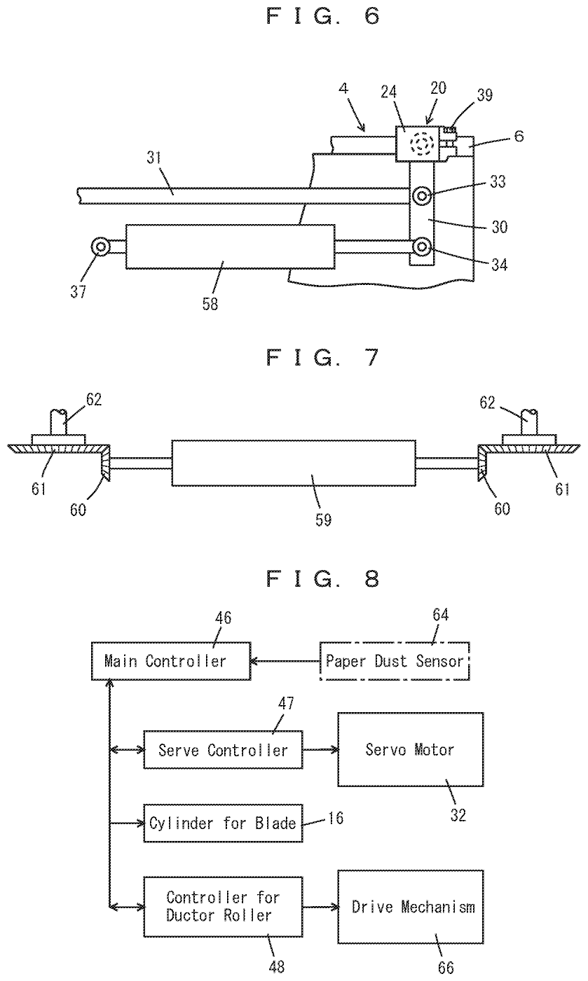

FIGS. 6 and 7 indicate modifications. If the clearance between the ink fountain 4 and the ink fountain roller 10 is not necessary to be adjusted according to the species of ink and so on, an air cylinder moving among three positions may be used in place of the servo motor 32. Or, instead of the servo motor 32, a pulse motor having a lower control precision may be used. Further, the left and right nuts 23, 23 may be rocked by a mechanism other than the quadric link 40. For example, as shown in FIG. 7, a servo motor 59 having a shaft extending towards both sides may be used; the shafts 62 connected to the nuts 23 may be rocked by bevel gears 60, 61 or the like. However, such a mechanism needs a wide space and has a large backlash due to the bevel gears 60, 61.

FIG. 8 indicates the control system of the printing press. The main controller 46 controls one unit of the printing press or the entire printing press, the servo controller 47 controls the servo motor 32, and the controller 48 for the ductor roller controls the drive mechanism 66, etc. of the ductor roller 12. The main controller 46 instructs the cleaning of the ink fountain 4 at a frequency of once an hour, etc. by a timer. Instead of the instruction by the timer for the cleaning, a paper dust sensor 64 may be used for the instruction of the cleaning. When paper dust increases in the ink reservoir 18, the clearance between the ink fountain 4 and the ink fountain roller 10 is clogged, and the ink film 70 on the ink fountain roller 10 becomes thinner. The paper dust sensor 64 such as a camera or a line sensor monitors the density of the color in the ink film and, when the ink film becomes pale, the cleaning is instructed. More, the cleaning may be instructed for every predetermined number of printing sheets. Further, the decrease in the printing density due to the paper dust may be detected and used to instruct the cleaning. Alternatively, workmen may manually instruct the main controller 46 to clean.

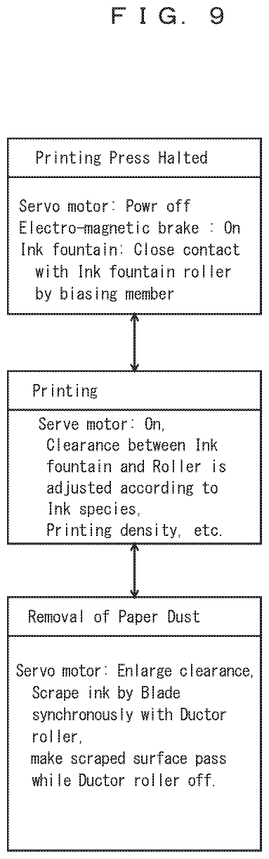

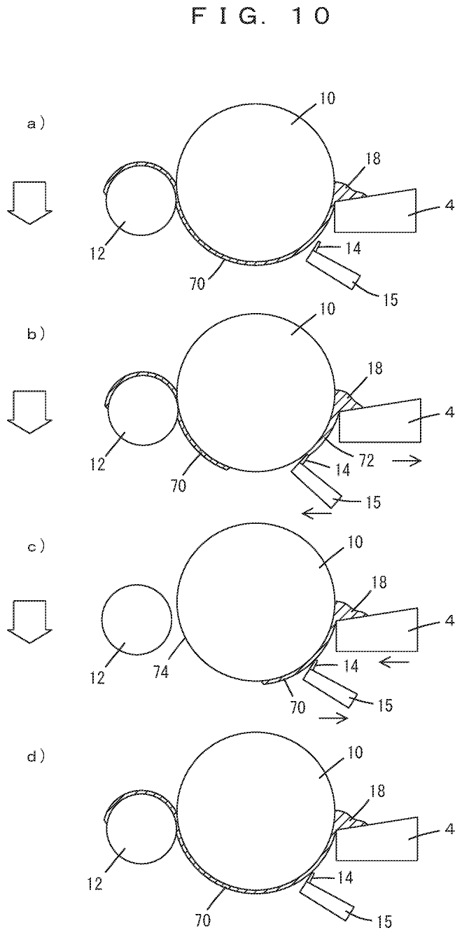

FIGS. 9 and 10 indicate the control algorithm according to the embodiment. Before halting the printing press, the servo motor 32 rocks the arms 30 to the closed position. When the printing press is halted, the power supply to the servo motor 32 is stopped, and a built-in electromagnetic brake fixes the shaft 35, and therefore, the arms 30 are also fixed. Further, the biasing members 52 make the ink fountain 4 in close contact with the ink fountain roller 10 so that the ink leakage is prevented.

When the operation of the printing press is started (FIG. 10a)), the servo motor 32 is made on, and the clearance between the ink fountain and the ink fountain roller is adjusted according to the species of ink and printing densities, etc. With a timer and so on or with the paper dust sensor 64, the ink fountain is cleaned at an appropriate frequency. During the cleaning, the ink fountain 4 is retracted from the ink fountain roller 10 in order to enlarge the clearance, and the clogged ink by paper dust, etc. are made to pass through the clearance (FIG. 10b)). Thus, a thick ink film 72 is generated, is scraped by the blade 14, and dirt such as paper dust is removed. Further, when the ink film is scraped by the blade 14, on the ink fountain roller 10, a cleaned surface 74 without the ink film is generated. When possible, the timing of the cleaning is controlled in such a way that the cleaned surface 74 passes through the clearance when the ductor roller 12 is retracted from the ink fountain roller 10 (FIG. 10c)). The ink fountain 4 and the blade 14 are returned to their normal positions before the ductor roller 12 is next made in contact with the ink fountain roller 10, and the cleaning is terminated (FIG. 10d)).

According to the embodiment, the following advantageous effects are resultant:
1) Dirt in ink such as paper dust is automatically removed without halting the printing, and the fluctuations in the printing density are made smaller, while the ink film 72 on the ink fountain roller 10 is scraped;
2) The ink fountain 4 is made advanced and retracted among the three positions of normal, close contact, and cleaning, and, in particular, at the normal position, the clearance between the ink fountain roller 10 and the ink fountain 4 is accurately controlled by the servo motor 32;
3) The quadric link 40 makes the left and right arms 30, 30 rock by the same angle;
4) The biasing member 52 removes the backlash caused by the screw 22 and nut 23 or the like and keeps the clearance between the ink fountain roller 10 and the ink fountain 4 at the desired width; further, when the power supply to the printing press is stopped, the ink fountain 4 is made in close contact with the ink fountain roller 10 in order to prevent ink leakage; and
5) The ink fountain 4 slides smoothly by the guide members 42.

Best Embodiment

FIGS. 11-14 indicate the best embodiment of the cleaning device for the ink reservoir, the printing press, and the cleaning method for the ink reservoir. In the best embodiment, characters already in FIGS. 1-10 indicate the same element, and except for the below-described matters, the best embodiment is the same as the embodiment in FIGS. 1-10.

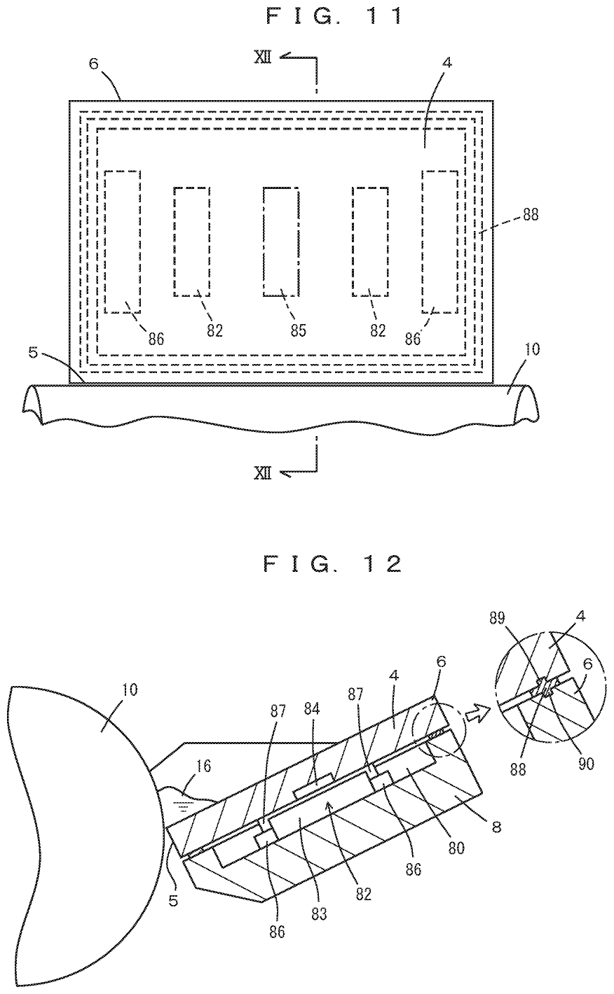

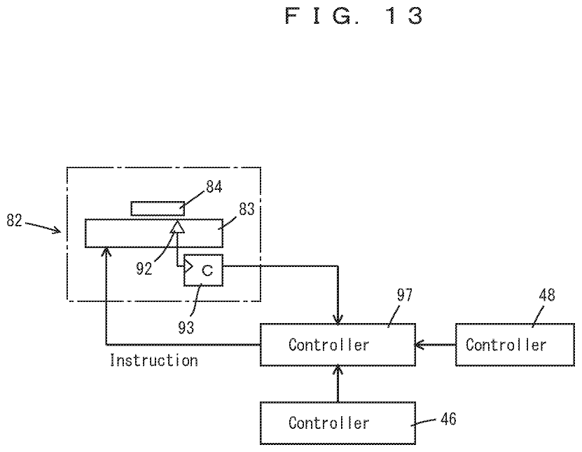

As shown in FIGS. 11 and 12, a left-right pair of linear motors 82, 82 and a left-right pair of linear guides 86, 86 are provided between the ink fountain 4 and the base 8 and they are accommodated within a concave portion 80 provided in the base 8. The linear motor 82 comprises a primary element 83 consisting of at least an electromagnet and an encoder and secondary element 84 consisting of at least a permanent magnet or an aluminum plate. The primary element 83 is provided at the side of the base 8, and the secondary element 84 is provided at the side of the ink fountain 4, for example. In the linear guide 86, the fixed part is provided at the side of the base 8, and the moving part 87 is provided at the side of ink fountain 4, for example.

Instead of the left and right linear motors 82, 82, one linear motor 85 may be provided at the center portion along the left-right direction of the ink fountain 4 and the base 8. Further, instead of the linear guides 86, the guide members 42 in FIG. 5 may be used. While not shown in the drawings, the ink fountain 4 and the base 8 are preferably covered by a sheet adapted to be fed and wound up.

Dirt such as ink mist are prevented from entering into the linear motors 82 and linear guides 86, preferably, by a seal 88 comprising a rubber packing, etc. enclosing the surrounding of the linear motors 82, 82 and the linear guides 86, 86. As shown enlarged in FIG. 12, the seal 88 is provided with upper and lower protrusions, and they are accommodated within a groove 89 in the ink fountain and a groove 90 in the base 8 and are fixed within the ink fountain 4 and the base 8.

In place of the rubber seal 88, a self-lubricant tape or a self-lubricant plate made of TEFLON (a registered trademark) or the like may be used. The self-lubricant seal endures against the repetitive sliding motion of the ink fountain 4 and blocks the ink mist, etc. since no gaps are generated between the ink fountain 4 and between the base 8.

The linear motors 82 lose the holding force when the power supply is cut. Therefore, the ink fountain 4 touches at the tip end 5 to the ink fountain roller 10 and the ink fountain 4 slides by its own weight to the closed position. Here, the force from the ink fountain 4 to the ink fountain roller 10 is less than the self-weight of the ink fountain 4.

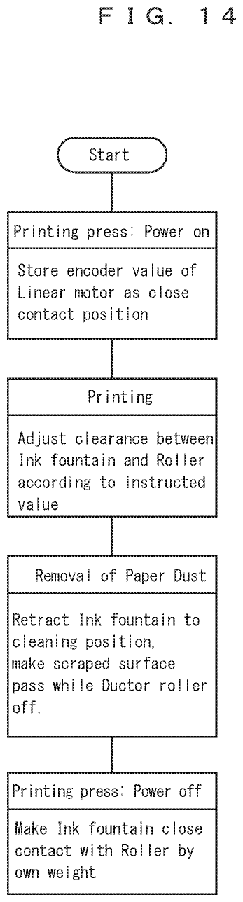

FIG. 13 indicates the control system of the linear motor 82. The optical or magnetic encoder 92 outputs positive or negative pulses when detecting the positional change of the secondary element 84, and the counter 93 accumulates the pulse numbers. When the power supply of the linear motor 82 is made on, the output of the counter 93 is one for the position where the ink fountain 4 is in close contact with the ink fountain roller 10. Therefore, the controller 97 controlling the pair of the linear motors 82, 82 stores the outputs for respective linear motors when the power supply is made on as the outputs at the origin (the closed position). Further, the controller 97 controls the linear motors 82, 82 so that the differences from those at the origin point are equal to the object value at the normal positions and so on.

FIG. 14 indicates the control algorithm of the best embodiment. The alterations from the algorithm in FIG. 9 are: storing the outputs of the counters 93 (encoder values) when the power supply was made on as the outputs corresponding to the origin; and, when the power supply is made off, the ink fountain 4 slides to the closed position by the self-weight.

Modification

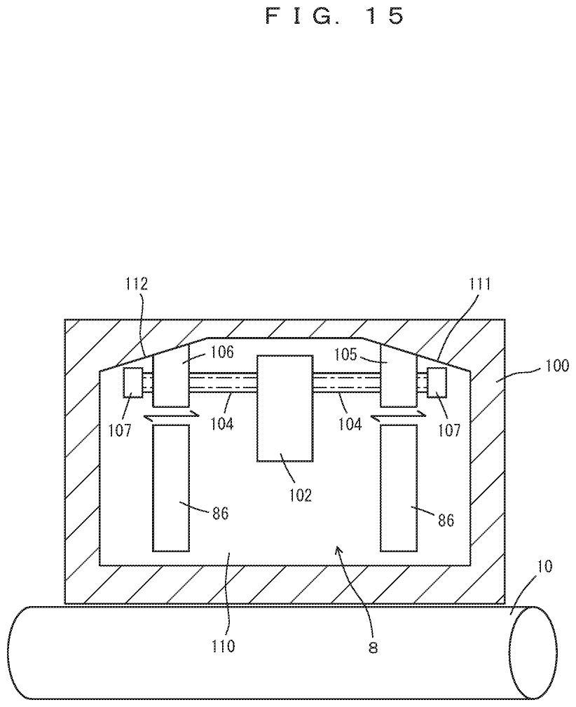

FIG. 15 indicates a modification where a rotation-type servo motor 102 is provided between the ink fountain 100 and the base 8. The servo motor 102 rotates a screw 104. The screw 104 is engaged with nuts in a left-right pair of cams 105, 106 and is supported by bearing 107, 107 at its both ends. These members are accommodated within a concave portion 110 in the base 8. A left-right pair of slopes 111, 112 are provided on the bottom of the ink fountain 100, and the sliding motion of the cams 105, 106 along the left-right direction is converted to the forth and back motion of the ink fountain 100. Since the engagement between the screw 104 and the cams 105, 106 causes a backlash, the ink fountain 100 is elastically pressed towards the ink fountain roller 10 by a biasing member not shown. Further, when the ink fountain 100 is slightly retracted from the closed position before the power supply is cut, the ink fountain advances to the closed position by the biasing member.

Supplements

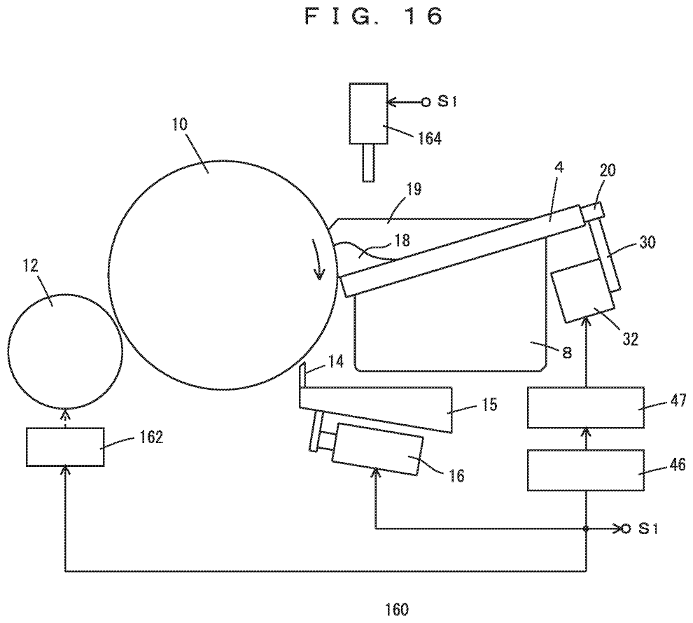

FIGS. 16-19 show supplements to the embodiment. In FIG. 16, a printing press 160 is provided with a driving device 162 moving forth and back individual rollers of the ductor roller 12 towards the ink fountain roller 10 and an ink feeding device 164 feeding ink to the ink reservoir 18. In FIG. 16, the left-right pair of the feed screw mechanisms 20 are driven by the servo motor 32 and the quadric link. However, the ink fountain 4 may be slid by the linear motor 82 shown in FIG. 12. Here, the controller 46 controls the driving device 162 and the ink feeding device 164, and S1 indicates the control signal for the ink feeding device 164. Unless otherwise specified, the modification is the same to that of the embodiment in FIGS. 1-10 and that of the best embodiment in FIGS. 11-14.

At the left side of the ductor roller 12 in FIG. 16, plural ink distributing rollers, the plate cylinder, and the blanket cylinder are provided. The ink received by the ductor roller 12 from the ink fountain roller 10 is buffered on the ink distributing rollers, etc. and is supplied to the plate cylinder.

During the cleaning of the ink reservoir 18, ink is not transferred to the ductor roller, and therefore, the printing density may become lower. Counter-measures have been described in FIGS. 9 and 14, and more versatile example is shown in FIG. 17. In FIG. 17, ink is supplied to the ink reservoir both before and after cleaning in order to prevent the printing density from lowering. As a remark, when the ink quantity in the ink reservoir is increased, then the ink quantity passing through the clearance between the ink fountain and ink fountain roller is increased. The ink supply before cleaning is in order to increase the buffered quantity of ink on the ink distributing rollers and so on for preventing the printing density from lowering. The ink supply after cleaning is for restoring the buffered ink quantity decreased by cleaning. For example, half of the ink to be lost by cleaning is supplied before cleaning and the rest is supplied after cleaning. Preferably, ink is supplied both before and after cleaning but may be supplied only before cleaning or only after cleaning.

Another versatile measure for preventing the printing density from lowering is to increase the duty ratio of the ductor roller touching the ink fountain roller before or after cleaning. The ductor roller operates at a predetermined period, and the duty ratio of the ductor roller touching ink fountain roller is adjusted for the adjustment of the printing density. If the duty ratio is increased both before and after cleaning, the buffered ink quantity is increased before cleaning and is restored after the cleaning. Of course, only before cleaning, or only after cleaning, the duty ratio of the ductor roller touching the ink fountain roller may be increased.

FIG. 19 shows the synchronism between the divided ductor roller 12 and cleaning. In the divided ductor roller 12, individual rollers advance towards the ink fountain roller (on) and retract (off). At the end of the operational period T1, there is a period T2 when all individual rollers are retracted. After the ink fountain has retracted and the clearance between the ink fountain roller has been enlarged, there is a delay D2 concerning the rotation of the ink fountain roller from the ink fountain to the blade position, and is a delay D1 until reaching the position abutting the ductor roller from the ink fountain.

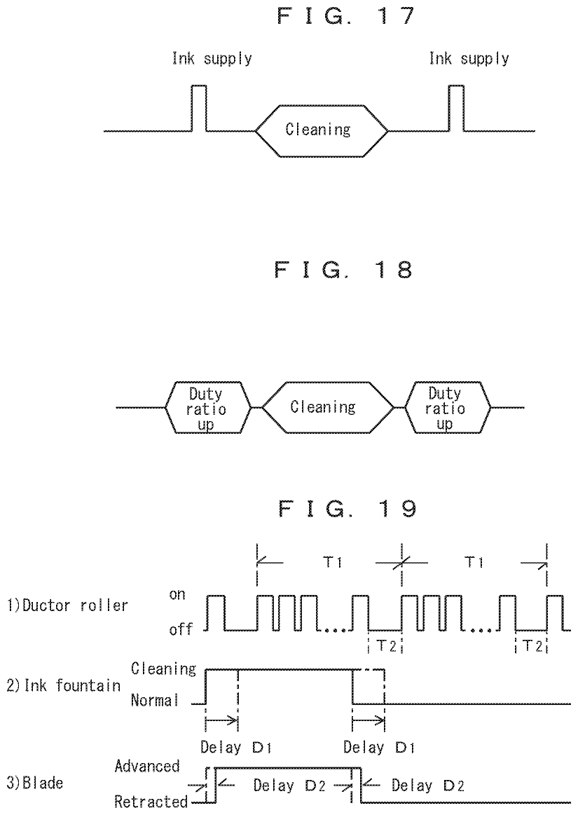

If the printing is slow and if the cleaning may be performed during the period T2, then, the cleaning does not affect the printing density. In this case, the processes in FIGS. 17 and 18 are not needed, and as shown in FIGS. 9 and 14, it is enough if the surface of the ink fountain roller where the ink film has been removed (cleaned surface) passes during the period T2 through the position abutting the ductor roller. However, if printing speed is high and therefore, the operational period of the ductor roller is short, the process in FIG. 17 or in FIG. 18 is performed, since the process in FIGS. 9 and 14 is difficult to be performed. Further, when the ductor roller comprises plural individual rollers, it is preferable to make cleaning influence over all individual rollers evenly. A measure for this is shown in FIG. 19.

1) in FIG. 19 indicates the operation of the ductor roller, 2) indicates the forth and back movement of the ink fountain, and 3) indicates the forth and back movement of the blade. If to the cleaned surface where the ink is removed by cleaning, all the individual rollers contact the same times, then the influence of the cleaning becomes uniform over the individual rollers. Therefore, the ink fountain is made slid and the blade is made advanced and retracted in order to fulfill this condition.

Description of Characters

| | | | |
|---|---|---|---|
| 2 | Cleaning Device | 4 | Ink Fountain |
| 5 | Tip End | 6 | Rear End |
| 8 | Base | 10 | Ink Fountain Roller |
| 12 | Ductor Roller | 14 | Blade |
| 15 | Pan | 16 | Cylinder |
| 17 | Ink Supply Portion | | |
| 18 | Ink Reservoir | 19 | Blade |
| 20 | Feed Screw Mechanism | 22 | Double Headed Screw |
| 23 | Nut | 24 | Fixing Member |
| 25 | Fixed Portion | 26 | Thrust Bearing |
| 27 | Intermediate Member | 28 | Biasing Member |
| 29 | Clearance | 30 | Arm |
| 31 | Rod | 32 | Servo Motor |
| 32a | Electro-Magnetic Brake | 33, 34 | Pin |
| 35 | Shaft | 36 | Screw |
| 37 | Pin | 38 | Dividing Groove |
| 39 | Bolt | 40 | Quadric Link |
| 41 | Clearance | 42 | Guide Member |
| 43 | Threaded Portion | 44 | Groove |
| 45 | Contact Portion | 46-48 | Controller |
| 50 | Fixing Member | 52 | Biasing Member |
| 53 | Bolt | 54 | Pin |
| 58 | Air Cylinder | 59 | Servo Motor |
| 60, 61 | Bevel Gear | 62 | Shaft |
| 64 | Paper Dust Sensor | 66 | Drive Mechanism |
| 70, 72 | Ink Film | 74 | Cleaned Surface |
| 80 | Concave Portion | 82, 85 | Linear Motor |
| 83 | Primary Element | 84 | Secondary Element |
| 86 | Linear Guide | 87 | Moving Part |
| 88 | Seal | 89, 90 | Groove |
| 92 | Encoder | 93 | Counter |
| 97 | Controller | 100 | Ink Fountain |
| 102 | Servo Motor | 104 | Screw |
| 105, 106 | Cam | 107 | Bearing |
| 110 | Concave Portion | 111, 112 | Slope |
| 160 | Printing Press | 162 | Drive Device |
| 164 | Ink Feeding Device | | |

1.-14. (canceled)

15. A cleaning device for an ink reservoir for a printing press, wherein the ink reservoir is formed between an ink fountain and an ink fountain roller and wherein ink is supplied to a ductor roller advancing and retracting towards and from the ink fountain roller,
wherein one end of the ink fountain towards the ink fountain roller is a tip end, an opposite end of the ink fountain far from the ink fountain roller is a rear end, and a direction parallel to the tip end is a left-right direction,
said cleaning device for an ink reservoir comprising: the ink fountain; a base supporting the ink fountain; and a slide mechanism sliding the ink fountain along the base in order to control a clearance between the tip end of the ink fountain and the ink fountain roller,
wherein said slide mechanism is configured to slide the ink fountain between a normal position where the ink passes through said clearance and a cleaning position where both dirt in the ink and the ink pass through said clearance,
said slide mechanism comprises:
a left-right pair of feed screw mechanisms comprising screws and nuts connected to and provided at the rear end of the ink fountain;
a left-right pair of arms rocking said nuts;
a rod connecting said left-right pair of arms rockingly;
a drive member rocking one of the arms; and
plural biasing members elastically pressing the ink fountain towards the ink fountain roller,
wherein the rear end of the ink fountain, the left-right pair of the feed screw mechanisms, the left-right pair of the arms, and the rod constitute a quadric link, and
wherein said slide mechanism is configured to slide the left and right two portions of the rear end of the ink fountain by a same stroke.

16. The cleaning device for an ink reservoir according to claim 15, further comprising a seal blocking the ink and provided between the ink fountain and the base.

17. The cleaning device for an ink reservoir according to claim 15, further comprising at least a guide member guiding the ink fountain along a sliding direction of the ink fountain, in line contact with the ink fountain, and provided between the base and bottom of the ink fountain.

18. The cleaning device for an ink reservoir according to claim 15, further comprising:
a cleaner removing the ink from the ink fountain roller;
an advancement and retraction mechanism advancing and retracting the cleaner between a contact position where the cleaner is in contact with the ink fountain roller and a non-contact position where the cleaner is not in contact with the ink fountain roller; and
a controller controlling said slide mechanism and said advancement and retraction mechanism and making the cleaner advance to the contact position in synchronization with the slide of the ink fountain to the cleaning position.

19. The cleaning device for an ink reservoir according to claim 18, further comprising a compensation means for increasing the quantity of the ink received by the ductor roller from the ink fountain roller before or after the slide of the ink fountain to the cleaning position.

20. The cleaning device for an ink reservoir according to claim 19, wherein said compensation means is configured to feed the ink to the ink reservoir before or after the slide of the ink fountain to the cleaning position.

21. The cleaning device for an ink reservoir according to claim 19,
wherein said ductor roller is configured to be in contact with the ink fountain roller at a variable duty ratio, and
wherein said compensation means is configured to increase said duty ratio before or after the slide of the ink fountain to the cleaning position.

22. The cleaning device for an ink reservoir according to claim 7,
wherein said ductor roller comprises plural individual rollers arranged along an axial direction of the ink fountain roller and advancing and retracting separately to contact the ink fountain roller, and
wherein said controller is configured to control the slide mechanism and the advancement and retraction mechanism so that said plural individual rollers are made, by a same number of times, in contact with a cleaned surface on the ink fountain roller from where the ink is removed by the cleaner, when sliding the ink fountain to the cleaning position.

23. The cleaning device for an ink reservoir according to claim 1, wherein said slide mechanism is configured to slide the ink fountain to three positions of the normal position, the cleaning position, and a closed position where the tip end of the ink fountain advances towards the ink fountain roller and prevents leakage of the ink through said clearance.

24. A printing press, wherein an ink reservoir is formed between an ink fountain and an ink fountain roller and wherein ink is supplied to a plate cylinder via a ductor roller advancing and retracting towards and from the ink fountain roller,
wherein one end of the ink fountain towards the ink fountain roller is a tip end, an opposite end of the ink fountain far from the ink fountain roller is a rear end, and a direction parallel to the tip end is a left-right direction,
the printing press comprising: the ink fountain; a base supporting the ink fountain; a slide mechanism sliding the ink fountain along the base in order to control a clearance between the tip end of the ink fountain and the ink fountain roller; a cleaner for removing the ink from the ink fountain roller; an advancement and retraction mechanism advancing and retracting the cleaner between a contact position where the cleaner is in contact with the ink fountain roller and a non-contact position where the cleaner is not in contact with the ink fountain roller; and a controller controlling said slide mechanism and said advancement and retraction mechanism,
wherein said slide mechanism is configured to slide the ink fountain between a normal position where the ink passes through said clearance and a cleaning position where both dirt in the ink and the ink pass through said clearance, and
wherein said controller is configured to control the slide mechanism and the advancement and retraction mechanism in order to make the cleaner advance to the contact position in synchronization with the slide of the ink fountain,
said slide mechanism comprises:
a left-right pair of feed screw mechanisms comprising screws and nuts connected to and provided at the rear end of the ink fountain;
a left-right pair of arms rocking said nuts;
a rod connecting said left-right pair of arms rockingly;
a drive member rocking one of the arms; and
plural biasing members elastically pressing the ink fountain towards the ink fountain roller,
wherein the rear end of the ink fountain, the left-right pair of the feed screw mechanisms, the left-right pair of the arms, and the rod constitute a quadric link, and
wherein said slide mechanism is configured to slide the left and right two portions of the rear end of the ink fountain by a same stroke.

25. A cleaning method for an ink reservoir for a printing press, wherein the ink reservoir is formed between an ink fountain and an ink fountain roller and wherein ink is supplied to a plate cylinder via a ductor roller advancing and retracting towards and from the ink fountain roller,
wherein one end of the ink fountain towards the ink fountain roller is a tip end, an opposite end of the ink fountain far from the ink fountain roller is a rear end, and a direction parallel to the tip end is a left-right direction,
the printing press comprising: the ink fountain; a base supporting the ink fountain; a slide mechanism sliding the ink fountain along the base in order to control a clearance between the tip end of the ink fountain and the ink fountain roller; a cleaner for removing the ink from the ink fountain roller; an advancement and retraction mechanism advancing and retracting the cleaner between a contact position where the cleaner is in contact with the ink fountain roller and a non-contact position where the cleaner is not in contact with the ink fountain roller; and a controller,
said slide mechanism comprises:
a left-right pair of feed screw mechanisms comprising screws and nuts connected to and provided at the rear end of the ink fountain;
a left-right pair of arms rocking said nuts;
a rod connecting said left-right pair of arms rockingly;
a drive member rocking one of the arms; and
plural biasing members elastically pressing the ink fountain towards the ink fountain roller,
wherein the rear end of the ink fountain, the left-right pair of the feed screw mechanisms, the left-right pair of the arms, and the rod constitute a quadric link, and
said method comprising: controlling said slide mechanism and said advancement and retraction mechanism by said controller; enlarging said clearance, and passing dirt in the ink and the ink through said clearance; making the cleaner in contact with the ink fountain roller; in synchronization with enlarging said clearance; and removing the dirt in the ink and the ink by the cleaner.

26. A cleaning device for an ink reservoir for a printing press, wherein the ink reservoir is formed between an ink fountain and an ink fountain roller and wherein ink is supplied to a ductor roller advancing and retracting towards and from the ink fountain roller,
wherein one end of the ink fountain towards the ink fountain roller is a tip end, and an opposite end of the ink fountain far from the ink fountain roller is a rear end,
said cleaning device for an ink reservoir comprising: the ink fountain; a base supporting the ink fountain; a slide mechanism sliding the ink fountain along the base in order to control a clearance between the tip end of the ink fountain and the ink fountain roller;
wherein said slide mechanism is configured to slide the ink fountain between a normal position where the ink passes through said clearance and a cleaning position where both dirt in the ink and the ink pass through said clearance,
a cleaner removing the ink from the ink fountain roller;
an advancement and retraction mechanism advancing and retracting the cleaner between a contact position where the cleaner is in contact with the ink fountain roller and a non-contact position where the cleaner is not in contact with the ink fountain roller;
a controller controlling said slide mechanism and said advancement and retraction mechanism and making the cleaner advance to the contact position in synchronization with the slide of the ink fountain to the cleaning position; and
a compensation means for increasing the quantity of the ink received by the ductor roller from the ink fountain roller before or after the slide of the ink fountain to the cleaning position.
